(19) United States
(12) Patent Application Publication
(10) Pub. No.: US 2011/0271852 A1
(43) Pub. Date: Nov. 10, 2011

(54) WEB PRODUCT EMBOSSING APPARATUS

(76) Inventor: Wei-Shuai LIN, (US)

(21) Appl. No.: 12/967,768

(22) Filed: Dec. 14, 2010

(30) Foreign Application Priority Data
May 7, 2010 (TW) 099114612

(51) Int. Cl. B31F 1/07

(52) U.S. Cl. 101/23

(57) ABSTRACT

A web product embossing apparatus includes a first embossing wheel set, a second embossing wheel set, a third embossing wheel set, and a glue applicator. The first embossing wheel set embosses at least one raised first embossed pattern on a first web product. The second embossing wheel set and third embossing wheel set respectively emboss at least one raised second embossed pattern and at least one raised third embossed pattern on a second web product. The glue applicator disposes adjacent to the third embossing wheel set to apply glue to the raised third embossed pattern. The first web product and the second web product are bonded together to form a soft and bulky embossed finished web product with multiple embossed patterns thereon.

### BACKGROUND OF THE INVENTION

1. Technical Field

The present invention relates to a web product embossing apparatus for bonding the first web product and the second web product together to form a soft and bulky embossed finished web product with multiple embossed patterns thereon.

2. Description of the Prior Art

FIG. 1 illustrates a conventional web product embossing apparatus. As illustrated, the web product embossing apparatus 10 comprises an embossing wheel set 11, a first transferring wheel 13, a second transferring wheel 14, a glue applicator 15 and a roller 17. The embossing wheel set 11 comprises a plurality of raised embossing portions for embossing multiple embossed patterns on a first web product 121. The first transferring wheel 13 and the second transferring wheel 14 are adapted for transferring the first web product 121 and a second web product 123.

The glue applicator 15 contacts with the first web product 121 at the roller 17 to apply a glue 16 to the first web product 121 for enabling the first web product 121 and the second web product 123 to be bonded together by the glue 16.

The first web product 121 is being transferred through the embossing wheel set 11, the raised embossing portions of the embossing wheel set 11 are forced against the first web product 121, forming multiple raised embossed patterns on the first web product 121. Because the raised embossed patterns of the first web product 121 protrude outwards, the glue applicator 15 applies the glue 16 to the raised embossed patterns of the first web product 121 when the first web product 121 is being transferred through the gap in between the glue applicator 15 and the flat surface of the roller 17.

After application of the glue 16, the first web product 121 and the second web product 123 are bonded together to form a finished web product 12. Further, in actual practice, the web product embossing apparatus 10 is able to emboss multiple embossed patterns on the finished web product 12. However, the patterns of the finished web product 12 may sink during manufacturing or using process, and fail to form a soft and bulky embossed finished web product.

### SUMMARY OF THE PRESENT INVENTION

It is, therefore, the main object of the present invention to provide a web product embossing apparatus, which comprises a first embossing wheel set, a second embossing wheel set and a third embossing wheel set. The first embossing wheel set embosses embossed patterns on the first web product, and the second embossing wheel set and the third embossing wheel set emboss embossed patterns on the second web product, forming a soft and bulky finished web product.

It is another object of the present invention to provide a web product embossing apparatus, which comprises a transferring unit for transferring a third web product to the third embossing wheel set, and bonding the first web product, the second web product, and the third web product for forming a thick finished web product.

It is still another object of the present invention to provide a web product embossing apparatus, wherein the second web product comprises raised second embossed patterns and raised third embossed patterns. The raised second embossed patterns are capable of supporting the raised third embossed pattern for forming a soft and bulky finished web product.

It is still another object of the present invention to provide a web product embossing apparatus, wherein the third embossing wheel set embosses raised third embossed patterns on the third web product. The raised second embossed patterns of the second web product are capable of supporting the raised third embossed patterns on the third web product.

It is still another object of the present invention to provide a web product embossing apparatus, which is adapted for bonding three or more web products to form a thick and bulky finished web product. Moreover, the web product sandwiched between others web products can be prepared from a relatively inferior material to reduce the cost without affecting the product quality.

It is still another object of the present invention to provide a web product embossing apparatus, which comprises a plurality of glue applicators to apply different kind of colors on the different pattern units of an embossed pattern, so that a single embossed pattern contains two or more colors.

To achieve these and other objects of the present invention, the present invention provides a web product embossing apparatus, comprising: a first embossing wheel set comprising a first embossing wheel and a second embossing wheel for embossing at least one raised first embossed pattern on a first web product; a second embossing wheel set comprising a third embossing wheel and a fourth embossing wheel for embossing at least one raised second embossed pattern on a second web product; a third embossing wheel set comprising a fifth embossing wheel and a sixth embossing wheel that comprises a plurality of protrusions raised from the periphery thereof, wherein the third embossing wheel set receives the second web product from the second embossing wheel set for embossing at least one raised third embossed pattern on a second web product; and a glue applicator disposed adjacent to the third embossing wheel set for applying a glue to the raised third embossed pattern.

### BRIEF DESCRIPTION OF THE DRAWINGS

FIG. 1 is a schematic structural view of a web product embossing apparatus, according to the prior art.

FIG. 2 is a schematic structural view of a web product embossing apparatus in accordance with an embodiment of the present invention.

FIGS. 2A and 2B are enlarged view of different parts of the web product embossing apparatus of FIG. 2.

FIGS. 3A and 3B are schematic sectional views of finished web products made according to the present invention.

FIG. 4 is a schematic structural view of the web product embossing apparatus in accordance with another embodiment of the present invention.

FIGS. 5A and 5B are schematic sectional views of finished web products made according to the present invention.

FIG. 6 is a schematic structural view of the web product embossing apparatus in accordance with another embodiment of the present invention.

FIGS. 6A˜6C are enlarged view of different parts of the web product embossing apparatus of FIG. 6.

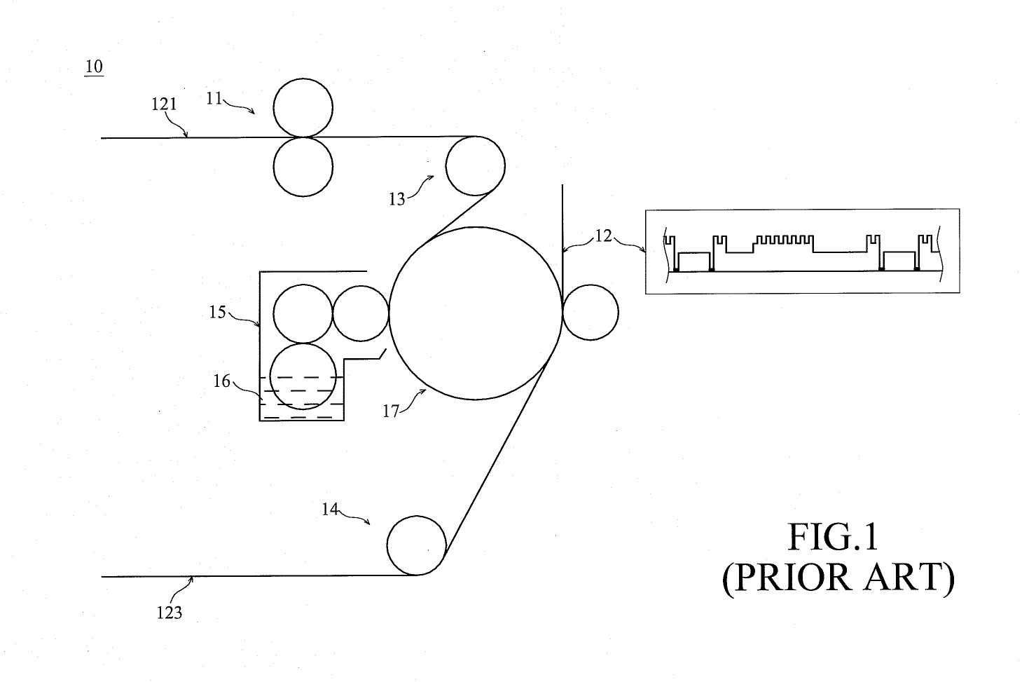

### DETAILED DESCRIPTION OF THE PREFERRED EMBODIMENTS

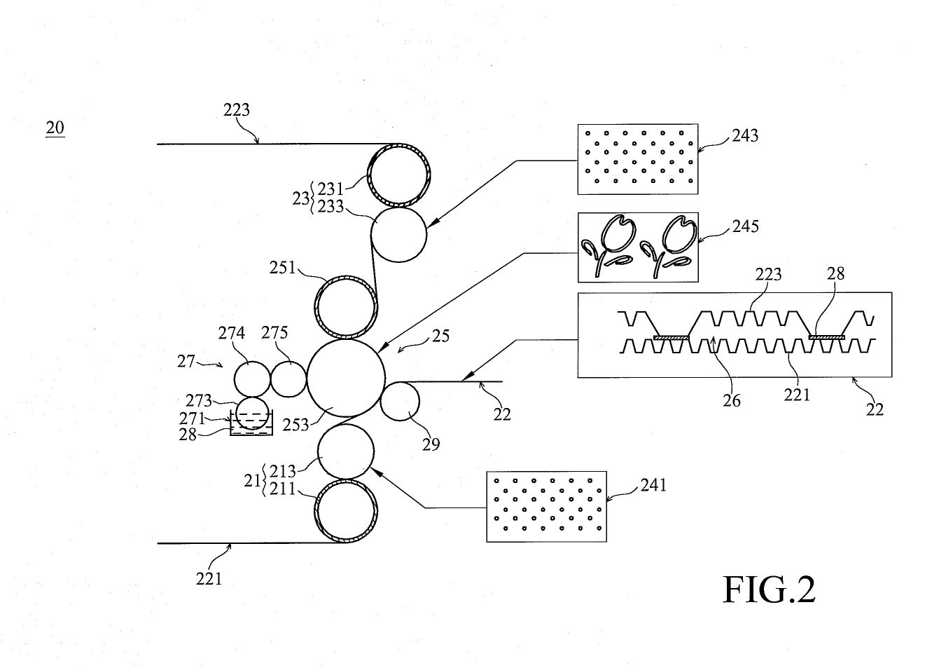

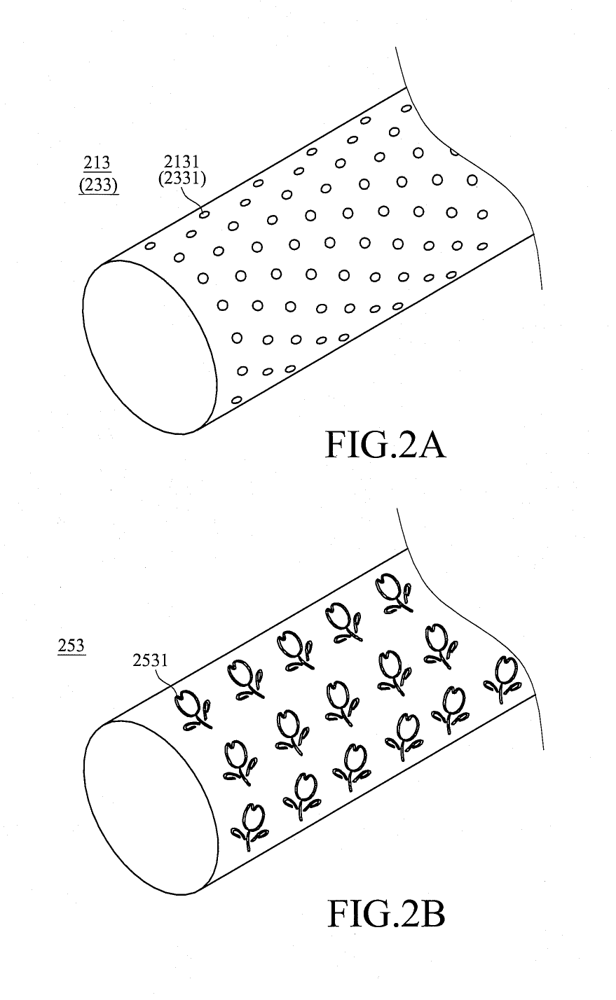

Please refer to FIG. 2, a web product embossing apparatus in accordance with an embodiment of the present invention is shown. The web product embossing apparatus 20 comprises a first embossing wheel set 21, a second embossing wheel set 23, a third embossing wheel set 25, and a glue applicator 27. The first embossing wheel set 21 embosses embossed patterns on a first web product 221, and the second embossing wheel set 23 and the third embossing wheel set 25 emboss embossed patterns on a second web product 223. The glue applicator 27 is adapted for applying a glue to the second web product 223.

The first embossing wheel set 21 is adapted for transferring the first web product 221 and embossing at least one raised first embossed pattern 241 on the first web product 221. According to this embodiment, the first embossing wheel set 21 comprises a first embossing wheel 211 and a second embossing wheel 213. The first embossing wheel 211 and the second embossing wheel 213 are rotatably abutted against each other for transferring the first web product 221 therebetween. When the first embossing wheel 211 and the second embossing wheel 213 are rotated, they transfer the first web product 221 forwards, forming a raised first embossed pattern 241 on the first web product 221.

The first embossing wheel 211 is prepared from an elastically deformable material. The second embossing wheel 213 is prepared from a non-deformable material. According to this embodiment, the first embossing wheel 211 is a rubber wheel, and the second embossing wheel 213 is a steel wheel having protrusions 2131 raised from the periphery thereof. For example, the protrusions 2131 are configured subject to the shape of the raised first embossed pattern 241. Upon contact between the second embossing wheel 213 and the first embossing wheel 211, the first embossing wheel 211 is forced to deform by the protrusions 2131 of the second embossing wheel 213, allowing the protrusions 2131 of the second embossing wheel 213 to sink into the periphery of the first embossing wheel 211, and therefore a raised first embossed pattern 241 is embossed on the first web product 221, as shown in FIG. 2A.

The structure of the second embossing wheel set 23 is similar with the first embossing wheel set 21. The second embossing wheel set 23 is adapted for transferring a second web product 223 and comprises a third embossing wheel 231 and a fourth embossing wheel 233. The third embossing wheel 231 is a rubber wheel, and the fourth embossing wheel 233 is a steel wheel having protrusions 2331 raised from the periphery thereof. For example, the protrusions 2331 are configured subject to the shape of the raised second embossed pattern 243. The second embossing wheel set 23 embosses at least one raised second embossed patterns 243 on the second web product 223, and then transfers the second web product 223 to the third embossing wheel set 25, as shown in FIG. 2A.

The third embossing wheel set 25 comprises a fifth embossing wheel 251 and a sixth embossing wheel 253, and receives the second web product 223 from the second embossing wheel set 23. The fifth embossing wheel 251 is a rubber wheel, and the sixth embossing wheel 253 is a steel wheel having protrusions 2531 raised from the periphery thereof. For example, the protrusions 2531 are configured subject to the shape of the raised third embossed pattern 245 for embossing at least one raised third embossed patterns 245 on the second web product 223, as shown in FIG. 2B.

The glue applicator 27 is disposed adjacent to the third embossing wheel set 25 for applying glue 28 to the second web product 223. For example, the glue applicator 27 comprises a glue reservoir 271, a first roller 273, a second roller 274 and a glue applicator wheel 275. The glue reservoir 271 holds the glue 28, and the first roller 273 is disposed adjacent to the glue reservoir 271, and rotatable to transfer the glue 28 to second roller 274. The second roller 274 is rotatable to transfer the glue 28 to the glue applicator wheel 275 uniformly. The glue applicator wheel 275 is kept in contact with the second web product 223 at the third embossing wheel set 25 for applying the glue 28 to the second web product 223. Moreover, the raised third embossed patterns 245 on the second web product 223 at the third embossing wheel set 25 is raised from the periphery thereof, and the glue 28 from the glue applicator 27 is remained on raised third embossed patterns 245.

The glue 28 may contain a pigment and/or perfume. During rotation of the first roller 273, the pigment and/or perfume is well mixed in the glue 28, making a color or perfume to the glue 28. Further, the finished web product 22 that contains the glue 28 is a colorful or perfumed web product.

In one embodiment of the invention, the raised first embossed patterns 241 and the raised second embossed patterns 243 distributed uniformly on the surface of the first web product 221 and the second web product 223 are coarse patterns to form a larger gap 26 between the first web product 221 and the second web product 223. Thereafter, the first web product 221 and the second web product 223 are bonded together to form a soft and bulky finished web product 22.

The raised third embossed pattern 245 is fine pattern, such as flower patterns, animal patterns or cartoon patterns, to form a diverse finished web product 22. Moreover, the second web product 233 comprises raised second embossed patterns 243 and raised third embossed patterns 245, and the second patterns are capable of supporting the raised third embossed pattern 245.

The web product embossing apparatus 20 further comprising an impression unit 29 adapted for imparting a pressure to the first web product 221 against the second web product 223 so that the first web product 221 and the second web product 223 can be adhered together, forming a finished web product 22. The impression unit 29 can be, for example, an impression roller kept in proximity to the third embossing wheel set 25 so that the first web product 221 and the second web product 223 can be fed through the gap between the third embossing wheel set 25 and the impression unit 29 and bonded together.

The glue 28 is applied on the raised third embossed pattern 245, and the first web product 221 and the second web product 223 are adhered to each other via the glue 28 on the raised third embossed pattern 245 for forming a larger gap 26 between the first web product 221 and the second web product 223.

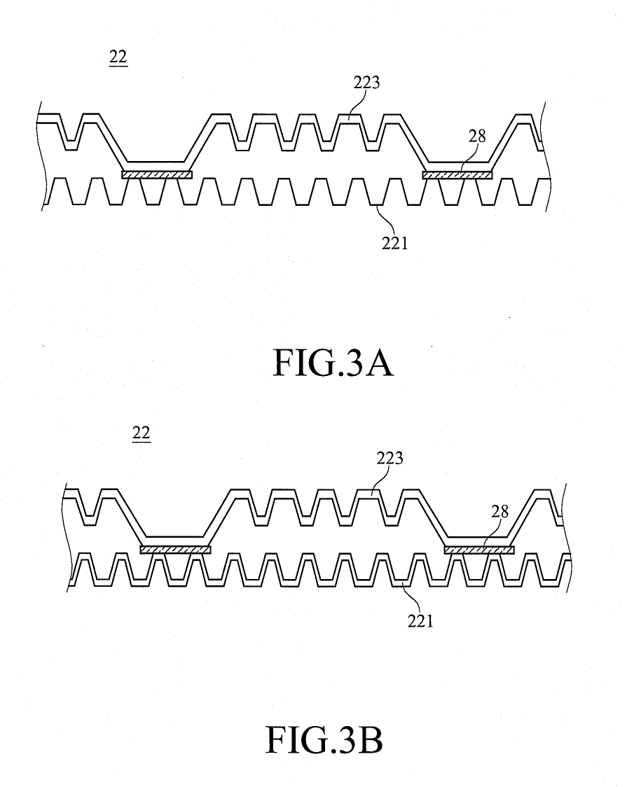

The first web product 221 and the second web product 223 are single-layer of paper, and the finished web product 22 is as shown in FIG. 2. The second web product 223 is a double-layer of paper and the first web product 221 is a single-layer of paper, and the finished web product 22 is as shown in FIG. 3A. In still another example of the present invention, the first web product 221 and the second web product 223 are double-layer of paper, and the finished web product 22 is as shown in FIG. 3B

The first web product 221 and the second web product 223 are adhered to each other via the glue 28 on the raised third embossed pattern 245. Furthermore, the raised third embossed pattern 245 is a coarse pattern for remaining more glue 28 thereon, and the first web product 221 and the second web product 223 are bonded stably each other.

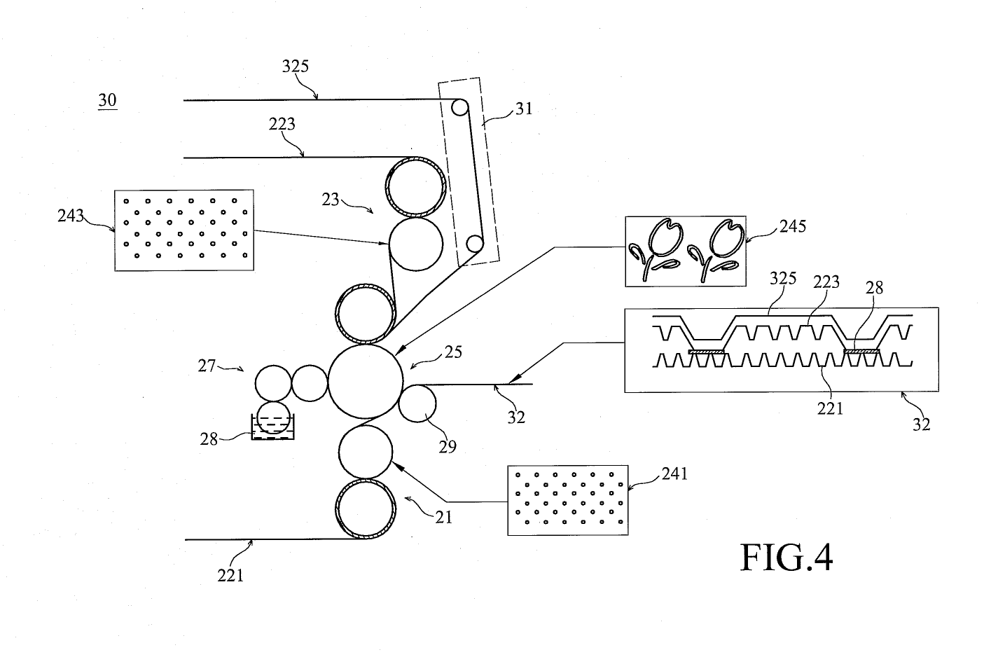

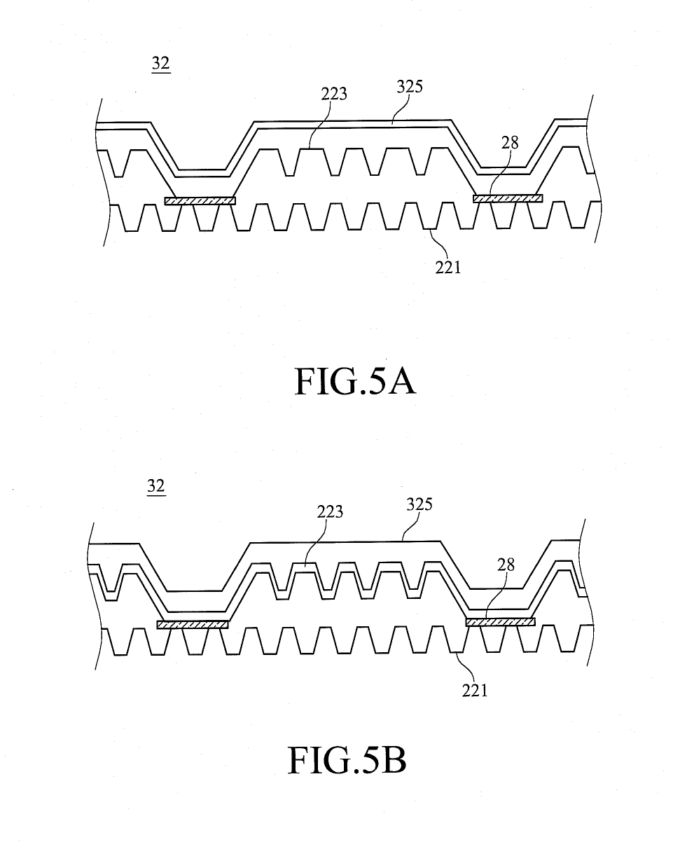

Referring to FIG. 4, a web product embossing apparatus in accordance with another embodiment of the present invention is shown. The web product embossing apparatus 30 comprises a first embossing wheel set 21, a second embossing wheel set 23, a third embossing wheel set 25, a transferring unit 31 and a glue applicator 27. The glue applicator 27 are arranged adjacent to the third embossing wheel set 25 and adapted for applying glue to a second web product 223 at the third embossing wheel set 25. Moreover, the transferring unit 31 transfers a third web product 325 to the third embossing wheel set 25 for bonding the first web product 221, the second web product 223 and the third web product 325 to form a finished web product 32.

According to this embodiment, the first web product 221 is firstly transferred through the first embossing wheel set 21 where the first embossing wheel set 21 embosses at least a raised first embossed pattern 241 on the first web product 221. The second web product 223 is firstly transferred through the second embossing wheel set 23 where the second embossing wheel set 23 embosses at least a raised second embossed pattern 243 on the second web product 223. The transferring unit 31 is adapted for transferring the third web product 325 to the third embossing wheel set 25 for enabling the second web product 223 and the third web product 325 to be overlapped and then embossed by the third embossing wheel set 25 to form a raised third embossed pattern 245 on the overlapped web product of the second web product 223 and the third web product 325.

The overlapped web product of the second web product 223 and the third web product 325 carry the raised third embossed pattern 245 (coarse pattern), and the second web product 223 carries the raised second embossed pattern 243 (fine pattern). Further, the raised second embossed pattern 243 on the second web product 321 is capable of supporting the raised third embossed pattern 245 on the third web product 325 and/or the second web product 223 for forming a soft and bulky embossed finished web product 32.

The first web product 221, the second web product 223 and the third web product 325 are single-layer of paper, and an impression unit 29 imparts a pressure to the first web product 221, the second web product 223 and the third web product 325 for forming a finished web product 32, as shown in FIG. 4. The third web product 325 is a double-layer of paper, and the first web product 221 and the second web product 223 are single-layer of paper, and the finished web product 32 is as shown in FIG. 5A. In still another example of the invention, the second web product 223 is double-layer of paper, and the first web product 221 and the third web product 325 are single-layer of paper, and the finished web product 22 is as shown in FIG. 5B

The finished web product 32 is a web product having at least three layers where the second web product 223 is sandwiched between the first web product 221 and the third web product 325 so that the user using the finished web product 32 does not touch the second web product 223 directly. Thus, the second web product 223 can be prepared from a relatively inferior material to reduce the cost without affecting the product quality.

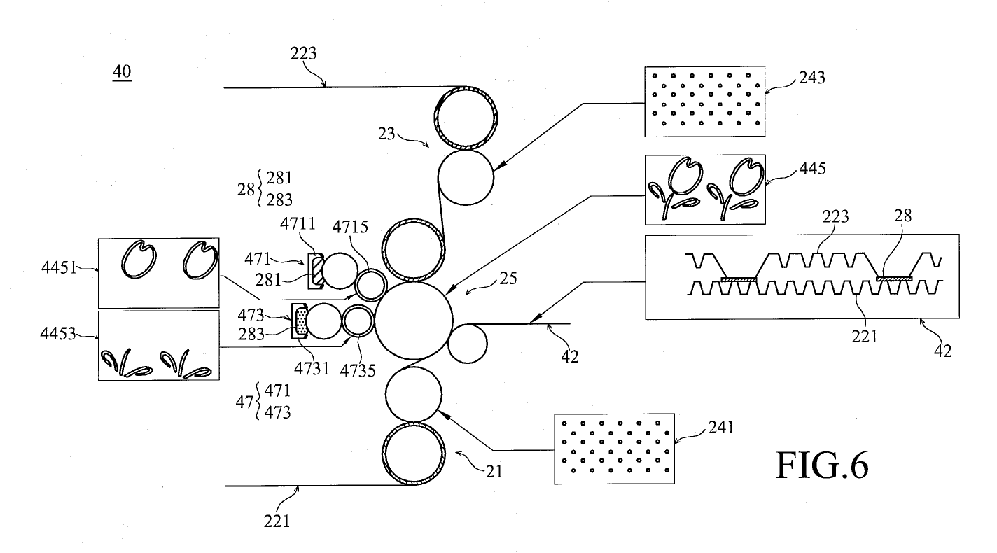

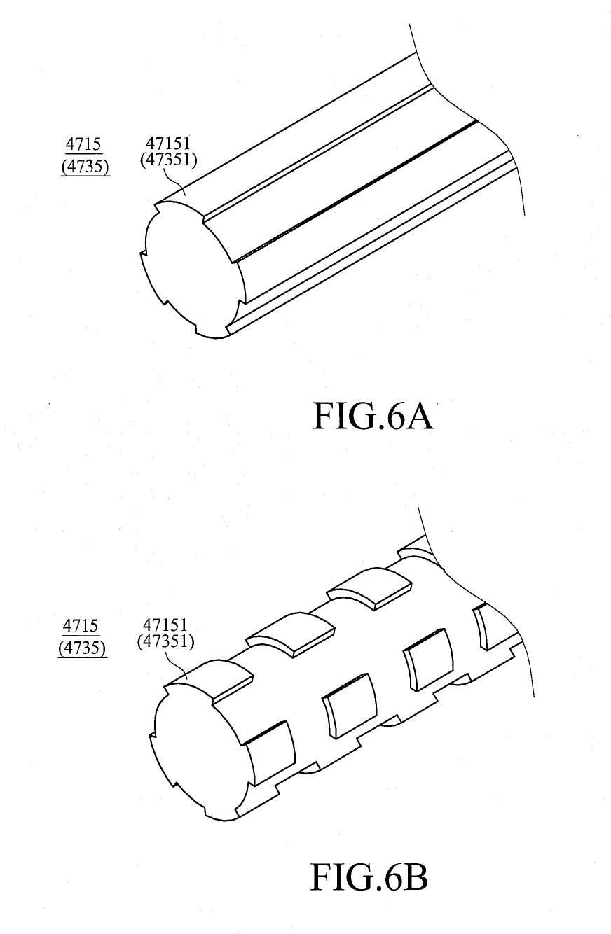

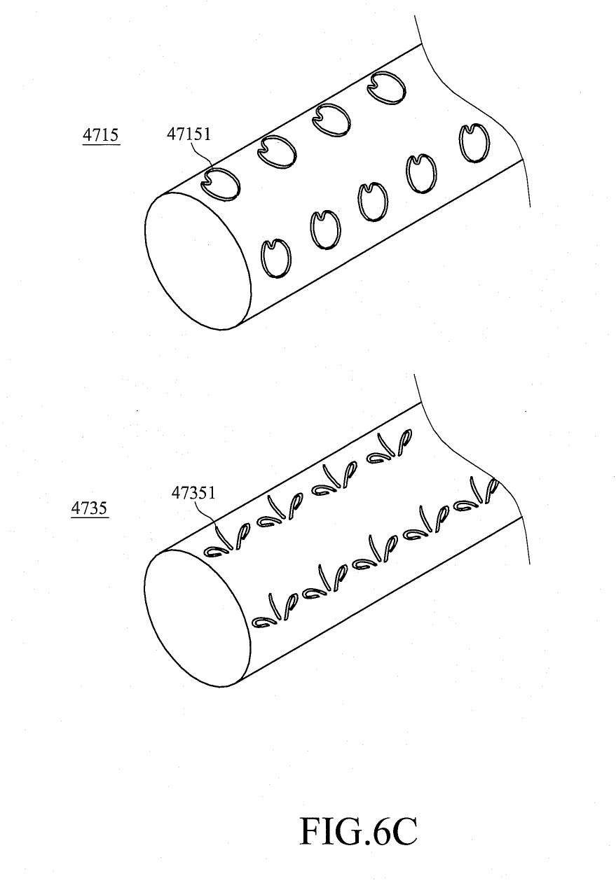

Please refer to FIG. 6, a web product embossing apparatus in accordance with another embodiment of the present invention is shown. The web product embossing apparatus 40 comprises a first embossing wheel set 21, a second embossing wheel set 23, a third embossing wheel set 25, and a plurality of glue applicators 47. Each glue applicator 47 is arranged adjacent to the third embossing wheel set 25 and adapted for applying glue to a second web product 223 at the third embossing wheel set 25.

According to this embodiment, firstly, the second embossing wheel set 23 embosses at least a raised second embossed pattern 243 on the second web product 223, and then transfers the second web product 223 to the third embossing wheel set 25 where the third embossing wheel set 25 embosses at least a raised third embossed pattern 445 on the second web product 223. The first embossing wheel set 21 embosses at least a raised first embossed pattern 241 on the first web product 221, and then bonds the first web product 221 and the second web product 223 to form a finished web product 42.

The web product embossing apparatus 40 comprises a plurality of glue applicators 47, and the raised third embossed pattern 445 comprises a plurality of pattern units 4451/4453. The glue applicators 47 apply different kind of glues with different color on the pattern units 4451/4453 of the raised third embossed pattern 445 respectively, and a single raise third embossed pattern 445 contains two or more colors. For example, the glue applicator 47 comprises a first glue applicator 471 and a second glue applicator 473, and the raised third embossed pattern 445 of the second web product 223 comprises a first pattern unit 4451 and a second pattern unit 4453. The first glue applicator 471 applies the first glue 281 that contains a first pigment on the first pattern unit 4451, and the second glue applicator 473 applies the second glue 283 that contains a second pigment on the second pattern unit 4453. The first pigment and the second pigment have different colors, so that the first pattern unit 4451 and the second pattern unit 4453 have different colors.

In one embodiment of the invention, the glue applicator wheels 4715/4735 have at least one or a plurality of glue applicator portions 47151/47351 raised from the periphery thereof. For example, the glue applicator portions 47151/47351 can be shaped like a long bar or configured subject to any of a variety of geometric shapes. Moreover, the glue applicator portions 47151/47351 can be configured subject to the designed first pattern unit 4451 and/or second pattern unit 4453, so that the glues 28 will be applied on the glue applicator portions 47151/47351 of the glue applicator wheels 4715/4735, as shown in FIG. 6A, FIG. 6B, and FIG. 6C. Moreover, only the glue applicator portions 47151/47351 contact with the first pattern unit 4451 and the second pattern unit 4453, and apply glues 28 thereon.

According to this embodiment, the numbers of the glue applicators 47 are two or more, and a single raised third embossed pattern 445 contains two or more colors.

Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A web product embossing apparatus, comprising:
a first embossing wheel set comprising a first embossing wheel and a second embossing wheel for embossing at least one raised first embossed pattern on a first web product;
a second embossing wheel set comprising a third embossing wheel and a fourth embossing wheel for embossing at least one raised second embossed pattern on a second web product;
a third embossing wheel set comprising a fifth embossing wheel and a sixth embossing wheel that comprises a plurality of protrusions raised from the periphery thereof, wherein said third embossing wheel set receives said second web product from said second embossing wheel set for embossing at least one raised third embossed pattern on said second web product; and
a glue applicator disposed adjacent to said third embossing wheel set for applying a glue to said raised third embossed pattern.

2. The web product embossing apparatus as claimed in claim 1, further comprising a transferring unit adapted for transferring a third web product to said third embossing wheel set.

3. The web product embossing apparatus as claimed in claim 2, wherein said third embossing wheel set embosses at least one raised third embossed pattern on said third web product.

4. The web product embossing apparatus as claimed in claim 3, further comprising an impression unit for imparting a pressure to said first web product, said second web product, and said third web product for forming a finished web product.

5. The web product embossing apparatus as claimed in claim 1, wherein said raised third embossed pattern comprises a plurality of pattern units, and the web product embossing apparatus comprises a plurality of glue applicators for applying different glues having different colors to different pattern units of each said raised third embossed pattern.

6. The web product embossing apparatus as claimed in claim 5, wherein said glue applicators each comprise a glue applicator wheel and a glue reservoir, and the glue reservoir of each said glue applicator holding a respective glue containing a respective color pigment.

7. The web product embossing apparatus as claimed in claim 6, wherein each said glue applicator wheel comprises at least one glue applicator portion raised from the periphery thereof.

8. The web product embossing apparatus as claimed in claim 5, wherein each said pattern unit of said raised third embossed pattern has different color.

9. The web product embossing apparatus as claimed in claim 5, wherein said glue applicators comprise a first glue applicator and a second glue applicator, and said raised third embossed pattern comprises a first pattern unit and a second pattern unit.

10. The web product embossing apparatus as claimed in claim 9, wherein said first glue applicator applies a first glue to said first pattern unit, and said second glue applicator applies a second glue to said second pattern unit.

11. The web product embossing apparatus as claimed in claim 10, wherein said first pattern unit and said second pattern unit have different color.

12. The web product embossing apparatus as claimed in claim 1, further comprising an impression unit for imparting a pressure to said first web product and said second web product for forming a finished web product.

13. The web product embossing apparatus as claimed in claim 1, wherein said first web product is a single-layer or double-layer of paper, and said second web product is a single-layer or double-layer of paper.

14. The web product embossing apparatus as claimed in claim 1, wherein said second web product comprises said raised second embossed pattern and said raised third embossed pattern.

15. The web product embossing apparatus as claimed in claim 1, wherein said protrusions are configured subject to the shape of said raised third embossed pattern.
